(19) United States
(12) Patent Application Publication
(10) Pub. No.: US 2013/0065152 A1
(43) Pub. Date: Mar. 14, 2013

(54) CHANNEL PLATE ASSEMBLY OF STACK FOR FUEL CELL AND METHOD OF MANUFACTURING CHANNEL PLATE ASSEMBLY

(71) Applicants: Joon-hee KIM, Seoul (KR); Hye-jung CHO, Anyang-si (KR); Kyoung-hwan CHOI, Suwon-si (KR)

(72) Inventors: Joon-hee KIM, Seoul (KR); Hye-jung CHO, Anyang-si (KR); Kyoung-hwan CHOI, Suwon-si (KR)

(73) Assignee: Samsung Electronics, Co., Ltd., Suwon-si (KR)

(21) Appl. No.: 13/433,992

(22) Filed: Mar. 29, 2012

(30) Foreign Application Priority Data
Sep. 9, 2011 (KR) 10-2011-0092228

(51) Int. Cl. H01M 8/04; H01M 8/02; H01M 8/24

(52) U.S. Cl. 429/457; 429/452

(57) ABSTRACT

A channel plate assembly of a stack for a fuel cell and a method of manufacturing the channel plate assembly. The channel plate assembly of a stack for a fuel cell includes a bridge piece disposed on a channel plate to entirely surround a manifold, and a gasket disposed on the channel plate to cover the bridge piece, wherein the channel plate assembly is manufactured in an integrated fashion.

### CROSS-REFERENCE TO RELATED APPLICATIONS

This application claims the benefit of Korean Patent Application No. 10-2011-0092228, filed on Sep. 9, 2011, in the Korean Intellectual Property Office, the disclosure of which is incorporated herein in its entirety by reference.

### BACKGROUND OF THE INVENTION

1. Field of the Invention

The present disclosure relates to a fuel cell, and more particularly, to a channel plate assembly of a stack for a fuel cell and a method of manufacturing the channel plate assembly.

2. Description of the Related Art

In general, a fuel cell is an electric energy generating apparatus that directly converts chemical energy of a fuel into electric energy via an electrochemical reaction, and may continually generate electricity as long as a fuel is supplied thereto. In the fuel cell, when air including oxygen is supplied to a cathode and a fuel gas such as methanol or hydrogen is supplied to an anode, electricity is generated from an electrochemical reaction performed via an electrolyte membrane between the cathode and the anode. In this regard, the air and the fuel necessary for the electrochemical reaction are supplied to a membrane electrode assembly (MEA) comprising a cathode, an anode, and an electrolyte membrane via manifolds and channels formed in a channel plate. On the other hand, electricity generated by a unit cell of the fuel cell has a low voltage, and thus the fuel cell is generally formed in the form of a stack in which a plurality of unit cells are connected to one another in series.

Meanwhile, in order to manufacture a stack for a fuel cell, a process of loading a bridge piece around a manifold of a channel plate and then loading a gasket on an edge of the channel plate is required. In this regard, the bridge piece prevents a channel connecting portion between the manifold and a channel from being blocked due to the gasket being pressed. However, since it takes a long time to perform the loading of the bridge piece and the gasket, time taken to manufacture the stack for a fuel cell is extended. Accordingly, in order to solve this and/or other problems, a method of integrally manufacturing a channel plate assembly comprising a channel plate, a bridge piece, and a gasket through injection molding of the gasket has recently attracted much attention. However, when the channel plate, the bridge piece, the gasket are integrally formed, a material of the gasket penetrates a gap between the channel plate and the bridge piece during the injection molding, thereby blocking a path formed around the manifold.

### SUMMARY OF THE INVENTION

Provided is a channel plate assembly of a stack for a fuel cell and a method of manufacturing the channel plate assembly.

Additional aspects will be set forth in part in the description which follows and, in part, will be apparent from the description, or may be learned by practice of the presented embodiments.

According to an aspect of the present invention, a channel plate assembly includes a channel plate in which first and second manifolds are formed to penetrate therethrough, wherein a first channel and a first channel connecting portion to connect the first manifold and the first channel are formed on a first surface of the channel plate; a first bridge piece disposed on the first surface of the channel plate to entirely surround the first manifold; and a first gasket disposed on the first surface of the channel plate to cover the first bridge piece.

The first bridge piece extends on the first channel connecting portion to surround the first manifold.

A first protruding portion entirely surrounding the first manifold is formed on the first surface of the channel plate, and the first bridge piece and the first gasket are formed around the first protruding portion.

A first gasket groove in which the first gasket is installed is formed on the first surface of the channel plate.

A first bridge piece groove in which the first bridge piece is installed is formed on the first surface of the channel plate to have a depth greater than that of the first gasket groove.

The first channel connecting portion is formed to have a depth greater than that of the first bridge piece groove.

The first bridge piece includes a conductive material.

The conductive material includes stainless steel or graphite.

The first bridge piece has a thickness corresponding to about 5 to 20% of a thickness of the channel plate.

The first gasket includes any material selected from the group consisting of ethylene proplylene M-class (EPDM) rubber, fluoro elastomers, nitrile-butadiene rubber (NBR), silicone, and fluorine silicone.

According to an aspect of the present invention, a second channel and a second channel connecting portion to connect the second manifold and the second channel are formed on a second surface of the channel plate, wherein the channel plate assembly further includes a second bridge piece disposed on the second surface of the channel plate to entirely surround the second manifold, and a second gasket disposed on the second surface of the channel plate to cover the second bridge piece.

The second bridge piece extends on the second channel connecting portion to surround the second manifold.

A second protruding portion is formed on the second surface of the channel plate to entirely surround the second manifold, and the second bridge piece and the second gasket is disposed around the second protruding portion.

The channel plate, the second bridge piece, and the second gasket are formed in an integrated fashion.

According to another aspect of the present invention, a stack for a fuel cell includes the above described channel plate assembly.

According to another aspect of the present invention, a method of integrally manufacturing the channel plate assembly includes: loading the first bridge piece on the first surface of the channel plate; and forming the first gasket on the first surface of the channel plate through injection molding to cover the first bridge piece.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plane view of a channel plate assembly of a stack for a fuel cell, according to an exemplary embodiment of the present invention;

FIG. 2 is an enlarged view of a part A illustrated in FIG. 1;

FIG. 3 is a cross-sectional view taken along a line III-III′ of FIG. 2;

FIG. 4 is a cross-sectional view taken along a line IV-IV' of FIG. 2;

FIG. 5 is a cross-sectional view taken along a line V-V′ of FIG. 2;

FIG. 6 is an enlarged view of a plane of a channel plate illustrated in FIG. 2;

FIG. 7 is a view of the channel plate illustrated in FIG. 6 on which a bridge piece is mounted, according to an exemplary embodiment of the present invention;

FIG. 8 is a bottom view of the channel plate assembly of a stack for a fuel cell illustrated in FIG. 1; and

FIG. 9 is an enlarged view of a part B illustrated in FIG. 8.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Now, an exemplary embodiment of the present invention will be described in detail with reference to the accompanying drawings. In the drawings, like reference numerals denote like elements throughout the specification, and the thicknesses of layers and regions are not drawn to actual size, nor necessarily drawn to scale, but are exaggerated for clarity.

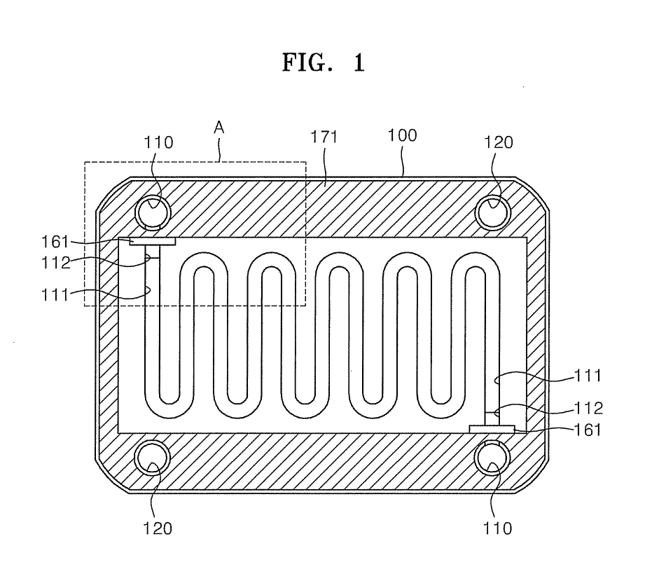

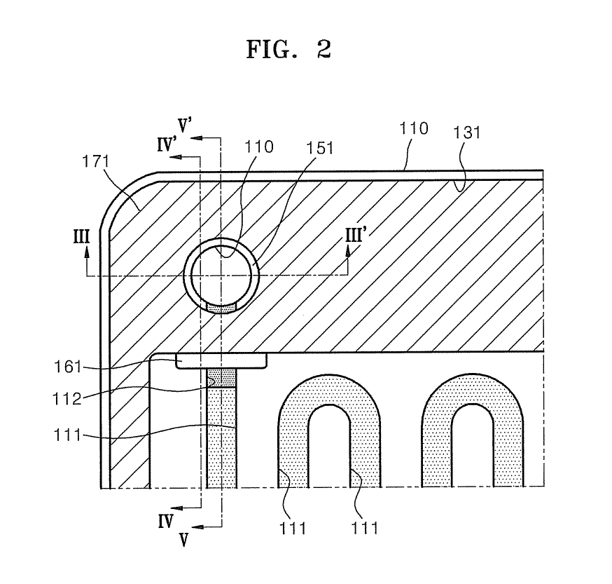

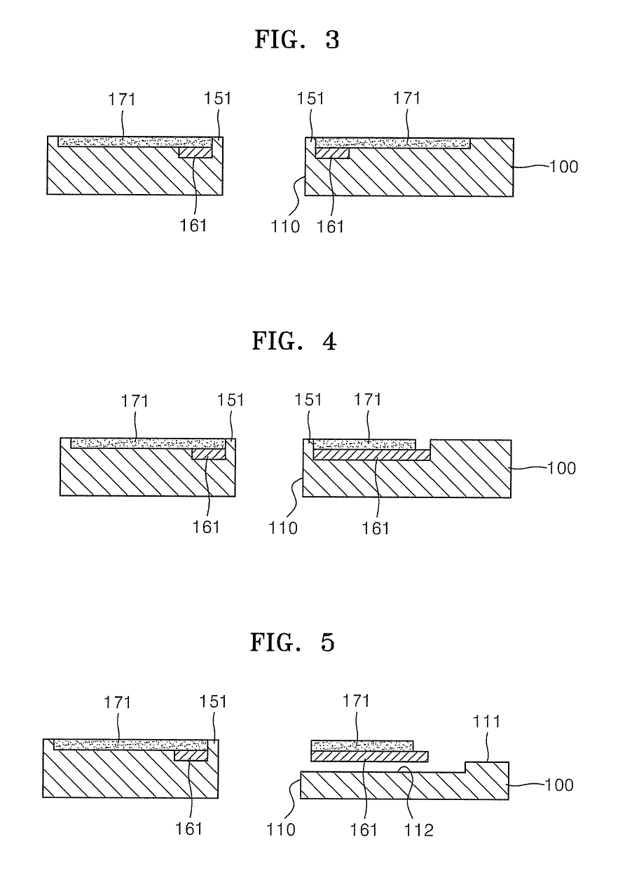

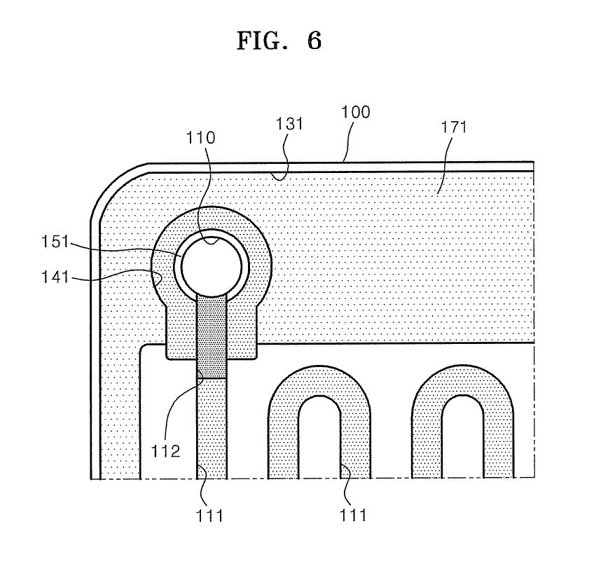

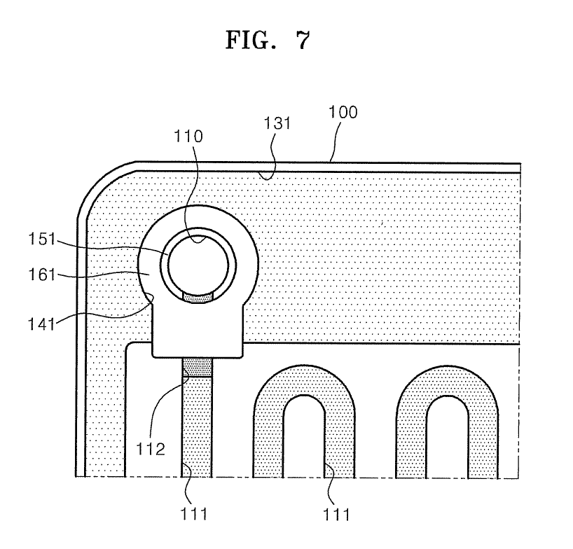

FIG. 1 is a plane view of a channel plate assembly of a stack for a fuel cell, according to an exemplary embodiment of the present invention. FIG. 2 is an enlarged view of a part A illustrated in FIG. 1. FIG. 3 is a cross-sectional view taken along a line III-III′ of FIG. 2. FIG. 4 is a cross-sectional view taken along a line IV-IV′ of FIG. 2. FIG. 5 is a cross-sectional view taken along a line V-V′ of FIG. 2. FIG. 6 is an enlarged view of a plane of a channel plate illustrated in FIG. 2. FIG. 7 is a view of the channel plate illustrated in FIG. 6 on which a bridge piece is mounted, according to an exemplary embodiment of the present invention.

Referring to FIGS. 1 to 7, the channel plate assembly of a stack for a fuel cell includes a channel plate 100, a pair of first bridge pieces 161 disposed on a first surface of the channel plate 100, and a first gasket 171 disposed on the first surface of the channel plate 100 and the first bridge pieces 161. A pair of first manifolds 110 and a pair of second manifolds 120 are formed to penetrate the channel plate 100. In this regard, a predetermined fluid, for example, a fuel such as methanol or hydrogen flows into the first manifolds 110. In this case, one of the first manifolds 110 is a path for supplying a fuel to a first channel 111 to be described later, and the other one is a path for discharging the fuel from the first channel 111. In addition, air including oxygen, for example, flows into the second manifolds 120. However, alternatively, the first manifolds 110 may be paths through which air flows, and the second manifolds 120 may be paths through which a fuel flows.

At least one first channel 111 is formed on the first surface of the channel plate 100 (for example, a top surface of the channel plate 100), wherein the first channel 111 is connected to the first manifolds 110 so that a fuel (or air) flows through the first channel 111. A plurality of first channel connecting portions 112 are formed between respective first manifolds 110 and the first channel 111 on the first surface of the channel plate 100 to connect the first manifolds 110 and the first channel 111. In this regard, the first channel connecting portions 112 are formed to have a depth greater than that of the first channel 111, but the present invention is not limited thereto. A first gasket groove 131 (see FIG. 6) is formed along an edge of the first surface of the channel plate 100, wherein the first gasket 171 is installed in the first gasket groove 131.

A plurality of first bridge piece grooves 141 are formed around the first manifolds 110 on the first surface of the channel plate 100. In detail (see FIG. 7), the first bridge piece grooves 141 are formed around respective first channel connecting portions 112, wherein first bridge pieces 161 are installed in the respective first bridge piece grooves 141. In this regard, the first bridge piece grooves 141 extend around the respective first channel connecting portions 112 and entirely surround the respective first manifolds 110. The first bridge piece grooves 141 are formed to have a depth greater than that of the first gasket groove 131 and less than that of the first channel connecting portions 112. First protruding portions 151 are respectively formed between the first manifolds 110 and the first bridge piece grooves 141 to entirely surround the respective first manifolds 110 except for portions where the first channel connecting portions 112 are formed. The channel plate 100 is formed of a conductive material and includes, for example, graphite. However, the present invention is not limited thereto, and the channel plate 100 may include various other materials.

The first bridge pieces 161 are installed in the respective first bridge piece grooves 141 as illustrated in FIG. 7. Accordingly, the first bridge pieces 161 are disposed to entirely surround the respective first manifolds 110. In detail, the first bridge pieces 161 extend over the respective first channel connecting portions 112 to surround the respective first manifolds 110. In this regard, the first bridge pieces 161 are disposed around the respective first protruding portions 151 to surround the first protruding portions 151. The first channel connecting portions 112 are formed to have a depth greater than that of the first bridge piece grooves 141, and thus the first manifolds 110 may be connected to the first channel 111 via the respective first channel connecting portions 112 formed below the first bridge pieces 161. The first bridge pieces 161 are formed of a material having conductivity and an anti-corrosion property. For example, the first bridge pieces 161 are formed of stainless steel, such as SUS, or graphite, but the present invention is not limited thereto. The first bridge pieces 161 have a thickness corresponding to about 5 to about 20% of a thickness of the channel plate 100, for example, a thickness corresponding to about 10% of the thickness of the channel plate 100, but the present invention is not limited thereto.

In general, the channel plate 100 has a thickness of less than 2 mm when used in a direct methanol fuel cell (DMFC). In this regard, the first bridge pieces 161 use stainless steel having a thickness of, for example, about 0.2 mm. However, this is just an example, and a material and a thickness of the first bridge pieces 161 may be modified in various ways. Meanwhile, the channel plate 100 may have a thickness of more than 2 mm when used in a polymer electrolyte membrane fuel cell (PEMFC), and accordingly, the first bridge pieces 161 are formed of any of various materials and formed to have any of various thicknesses and used in the channel plate 100.

The first gasket 171 is installed in the first gasket groove (131 of FIG. 7) as illustrated in FIG. 2. The first gasket 171 is disposed on the first surface of the channel plate 100 to cover the first bridge pieces 161. In addition, the first gasket 171 is disposed around the first protruding portions 151. The first gasket 171 is formed to seal an edge of the channel plate 100 to prevent a fuel or air from leaking, and the first gasket 171 is formed of an elastic material. The first gasket 171 includes, for example, ethylene proplylene M-class (EPDM) rubber, fluoro elastomers, nitrile-butadiene rubber (NBR), silicone, fluorine silicone, or the like. However, the present invention is not limited thereto, and the first gasket 171 may be formed of any of various materials.

The channel plate 100, the first bridge pieces 161, and the first gasket 171 are manufactured in an integrated fashion. That is, the first bridge pieces 161 and the first gasket 171 are integrally formed in the channel plate 100 by loading the first bridge pieces 161 on the channel plate 100 and then forming the first gasket 171 through injection molding. In detail, the first bridge pieces 161 are loaded in the respective first bridge piece grooves 141 of the channel plate 100. In this regard, the first bridge pieces 161 are disposed to entirely surround the respective first manifolds 110. The channel plate 100 in which the first bridge pieces 161 are loaded is put into a mold, and then the first gasket 171 is formed in the first gasket groove 131 through injection molding. A material used in the injection molding of the first gasket 171 are, as described above, EPDM rubber, fluoro elastomers, NBR, silicone, fluorine silicone, or the like. Thus, the channel plate 100, the first bridge pieces 161, and the first gasket 171 may be manufactured in an integrated fashion. In the current embodiment, the first bridge pieces 161 are formed to entirely surround the respective first manifolds 110, and thus a gasket material does not enter between the channel plate 100 and the first bridge pieces 161 during the injection molding for forming the first gasket 171, thereby preventing the first channel connecting portions 112 formed around the first manifolds 110 from being blocked.

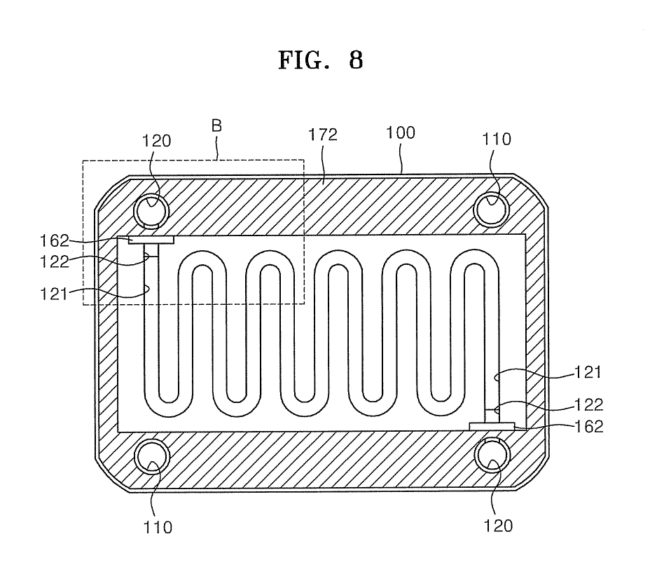

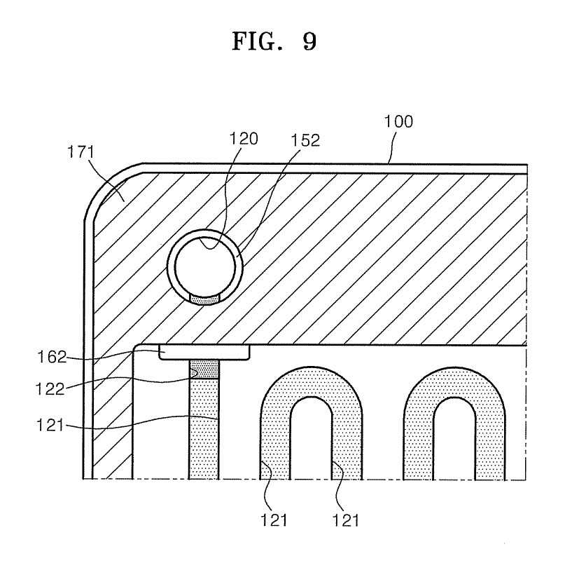

FIG. 8 is a bottom'view of the channel plate assembly of a stack for a fuel cell illustrated in FIG. 1, according to an embodiment of the present invention. FIG. 9 is an enlarged view of a part B illustrated in FIG. 8. Referring to FIGS. 8 and 9, at least one second channel 121 through which air (or a fuel) supplied from the second manifolds 120 is formed on a second surface of the channel plate 100, for example, a lower surface of the channel plate 100. A plurality of second channel connecting portions 122 are each formed on the second surface of the channel plate 100 to connect respective second manifolds 120 and the second channel 121. The second channel connecting portions 122 may each be formed to have a depth that is greater than that of the second channel 121, but the present invention is not limited thereto.

A plurality of second bridge pieces 162 are each be formed on the second surface of the channel plate 100 to entirely surround the respective second manifolds 120. In this regard, the second bridge pieces 162 extend from the respective second channel connecting portions 122 and surround the respective second manifolds 120. For this, a plurality of second bridge piece grooves (not shown) are formed on the second surface of the channel plate 100, wherein the second bridge pieces 162 are respectively installed in the second bridge piece grooves. The second bridge piece grooves extend around the second channel connecting portions 122 and entirely surround the second manifolds 120. The second bridge piece grooves are formed to have a depth less than that of the second channel connecting portions 122. Second protruding portions 152 are formed between the second manifolds 120 and the second bridge piece grooves to entirely surround the respective second manifolds 120 except for portions where the second channel connecting portions 122 are formed.

A second gasket 172 is formed on the second surface of the channel plate 100 to cover the second bridge pieces 162. For this, a second gasket groove (not shown) is formed along an edge of the second surface of the channel plate 100, wherein the second gasket 172 is installed in the second gasket groove (not shown). The second gasket groove is formed around the second protruding portions 152 and is formed to have a depth less than that of the second bridge piece grooves.

The second bridge pieces 162 and the second gasket 172 have the same functions as the first bridge pieces 161 and the first gasket 171, and thus a repeated description thereof will be omitted here. The second bridge pieces 162 are formed of a material having conductivity and an anti-corrosion property, for example, stainless steel or graphite. The second bridge pieces 162 have a thickness corresponding to about 5 to about 20% of the thickness of the channel plate 100, for example, a thickness corresponding to about 10% of the thickness of the channel plate 100. However, the above-described material and thickness of the second bridge pieces 162 are just examples and may be modified in various ways. The second gasket 172 includes an elastic material such as EPDM rubber, fluoro elastomers, NBR, silicone, fluorine silicone, or the like, although may also be made of other materials.

The channel plate 100, the second bridge pieces 162, and the second gasket 172 are manufactured in an integrated fashion. In detail, the second bridge pieces 162 are loaded in the second bridge piece grooves of the channel plate 100. Then, the channel plate 100 in which the second bridge pieces 162 are loaded is put into a mold, and then the second gasket 172 is formed in the second gasket groove through injection molding. Thus, the channel plate 100, the second bridge pieces 162, and the second gasket 172 are manufactured in an integrated fashion. Also, the second bridge pieces 162 are formed to entirely surround the respective second manifolds 120, and thus a gasket material does not enter between the channel plate 100 and the second bridge pieces 162 during the injection molding for forming the second gasket 172.

As described above, the channel plate assembly including the channel plate 100, the first and second bridge pieces 161 and 162, and the first and second gaskets 171 and 172 are integrally formed through injection molding. A stack for a fuel cell is formed by alternately stacking a plurality of the channel plate assemblies manufactured by using the above-described method and a plurality of membrane electrode assemblies (MEAs). In the manufacturing of the stack for a fuel cell, the above-described integrated type channel plate assembly is used to reduce time taken to manufacture the stack for a fuel cell. Meanwhile, in the above embodiment, the first and second channels 111 and 121 are formed on two surfaces of the channel plate 100, that is, on the first and second surfaces of the channel plate 100. However, the present invention is not limited thereto, and the first and second channels 111 and 121 may be formed on any one of the first and second surfaces of the channel plate 100.

According to aspects of the present invention, a bridge piece entirely surrounding a manifold is formed on a channel plate, and a gasket is formed thereon through injection molding, thereby preventing a path formed around the manifold connected to a channel from being blocked. Also, a channel plate assembly is formed in an integrated fashion, thereby reducing time taken to manufacture a stack for a fuel cell.

It should be understood that the exemplary embodiments described therein should be considered in a descriptive sense only and not for purposes of limitation. Descriptions of features or aspects within each embodiment should typically be considered as available for other similar features or aspects in other embodiments.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A channel plate assembly comprising:
a channel plate in which first and second manifolds are formed to penetrate therethrough, wherein a first channel and a first channel connecting portion to connect the first manifold and the first channel are formed on a first surface of the channel plate;
a first bridge piece disposed on the first surface of the channel plate to entirely surround the first manifold; and
a first gasket disposed on the first surface of the channel plate to cover the first bridge piece.

2. The channel plate assembly of claim 1, wherein the first bridge piece extends on the first channel connecting portion to surround the first manifold.

3. The channel plate assembly of claim 2, further comprising a first protruding portion entirely surrounding the first manifold and formed on the first surface of the channel plate, and the first bridge piece and the first gasket are formed around the first protruding portion.

4. The channel plate assembly of claim 1, further comprising a first gasket groove in which the first gasket is installed and formed on the first surface of the channel plate.

5. The channel plate assembly of claim 4, further comprising a first bridge piece groove in which the first bridge piece is installed and formed on the first surface of the channel plate to have a depth greater than that of the first gasket groove.

6. The channel plate assembly of claim 5, wherein the first channel connecting portion has a depth greater than that of the first bridge piece groove.

7. The channel plate assembly of claim 1, wherein the first bridge piece comprises a conductive material.

8. The channel plate assembly of claim 7, wherein the conductive material comprises stainless steel or graphite.

9. The channel plate assembly of claim 1, wherein the first bridge piece has a thickness corresponding to about 5 to 20% of a thickness of the channel plate.

10. The channel plate assembly of claim 1, wherein the first gasket comprises any material selected from the group consisting of ethylene proplylene M-class (EPDM) rubber, fluoro elastomers, nitrile-butadiene rubber (NBR), silicone, and fluorine silicone.

11. The channel plate assembly of claim 1, further comprising a second channel and a second channel connecting portion to connect the second manifold and the second channel and formed on a second surface of the channel plate, wherein the channel plate assembly further comprises a second bridge piece disposed on the second surface of the channel plate to entirely surround the second manifold, and a second gasket disposed on the second surface of the channel plate to cover the second bridge piece.

12. The channel plate assembly of claim 11, wherein the second bridge piece extends on the second channel connecting portion to surround the second manifold.

13. The channel plate assembly of claim 12, further comprising a second protruding portion formed on the second surface of the channel plate to entirely surround the second manifold, and the second bridge piece and the second gasket are disposed around the second protruding portion.

14. The channel plate assembly of claim 11, wherein the channel plate, the second bridge piece, and the second gasket are formed in an integrated fashion.

15. A stack for a fuel cell comprising the channel plate assembly of claim 1.

16. A stack for a fuel cell comprising the channel plate assembly of claim 11.

17. A method of manufacturing the channel plate assembly of claim 1, the method comprising:
loading the first bridge piece on the first surface of the channel plate; and
integrally forming the first gasket on the first surface of the channel plate through injection molding to cover the first bridge piece.

18. The method of claim 17, wherein the first bridge piece extends on the channel connecting portion to surround the first manifold.

19. The method of claim 18, wherein a first protruding portion is formed on the first surface of the channel plate to entirely surround the first manifold, and the first bridge piece and the first gasket are disposed around the first protruding portion.

20. A method of manufacturing the channel plate assembly of claim 11, the method comprising:
loading the first bridge piece on the first surface of the channel plate;
integrally forming the first gasket on the first surface of the channel plate through injection molding to cover the first bridge piece;
loading a second bridge piece on a second surface of the channel plate; and
integrally forming a second gasket on the second surface of the channel plate through injection molding to cover the second bridge piece.

21. A method of manufacturing a channel plate assembly for a fuel cell, wherein the channel plate assembly has a channel plate including a first channel, and a first channel connecting portion to connect a first manifold which penetrates through the channel plate and the first channel, the method comprising:
loading a first bridge piece on a first surface of a channel plate to entirely surround the first manifold; and
forming a first gasket in a first gasket groove of the channel plate and over the first bridge piece, to integrally form the first bridge piece, the first gasket and the channel plate.

22. The method of claim 21, wherein the integral forming of the first bridge piece, the first gasket and the channel plate, comprises using an injection molding process.

23. The method of claim 21, wherein the channel plate includes a second channel, and a second channel connecting portion to connect a second manifold which penetrates through the channel plate and the second channel, the method further comprising:
loading a second bridge piece on a second surface of the channel plate of the channel plate assembly to entirely surround the second manifold; and
forming a second gasket in a second gasket groove of the channel plate and over the second bridge piece, to integrally form the second bridge piece, the second gasket and the channel plate.

24. The method of claim 23, wherein the integral forming of the second bridge piece, the second gasket and the channel plate, comprises using an injection molding process.
